(19) United States
(12) Patent Application Publication
(10) Pub. No.: US 2025/0231826 A1
(43) Pub. Date: Jul. 17, 2025

(54) DETECTION AND REMEDIATION OF INSTABILITIES IN LARGE LANGUAGE MODELS

(71) Applicant: Intuit Inc., Mountain View, CA (US)

(72) Inventors: Yair HORESH, Tel Aviv (IL); Guy SHTAR, Ness Ziona (IL)

(73) Assignee: Intuit Inc., Mountain View, CA (US)

(21) Appl. No.: 18/414,451

(22) Filed: Jan. 16, 2024

(51) Int. Cl. G06F 11/07; G06F 40/40

(52) U.S. Cl. CPC G06F 11/0769; G06F 40/40

(57) ABSTRACT

A method including applying a test large language model to a test input to generate a test output. An encoding model is applied to the test input and test output to generate an encoded test input and an encoded test output. A cluster assignment model is applied to a combination of the encoded test input, the encoded test output, and a set of clusters. The cluster assignment model identifies an input cluster to which the encoded test input belongs and an output cluster to which the encoded test output belongs. A comparison model is applied to the input cluster and the output cluster to identify a relationship between the input cluster and the output cluster and to determine whether the relationship is one of multiple pre-existing relationships among the clusters. A result is returned responsive to the relationship failing to match at least one of the pre-existing relationships.

### BACKGROUND

A large language model is a generative machine learning model (e.g. a neural network) programmed to take an input text and repeatedly predict a next word or token until an output text is generated. Large language models are termed “large” because large language models are trained on vast amounts of text data to learn possibly billions of parameters during training. Large language models have many applications, such as automatic generation of reports, chatbots, summarization of large works of text, etc.

As a large language model is re-trained and refined, over time the output of the large language model may change. In some cases, the output of the large language model may become unexpected. Specifically, a large language model may perceive patterns or objects that are nonexistent or imperceptible to human observers, thereby creating outputs that are nonsensical to a human or that are factually incorrect. When a large language model generates such an output, the large language model may be said to “hallucinate,” though a large language model is incapable of hallucinating in the sense that a human being may hallucinate.

The tendency of a large language model to change over time may be described as “drift” (i.e., the parameters of a large language model may be said to drift, thereby causing the output of the large language model to change over time). However, technical challenges exist in automatically determining when a large language model drifts to an extent that a likelihood of large language model hallucination may become unacceptably high, or in automatically determining when a large language model should be retrained or replaced. More formally, a technical challenge exists in automatically determining when a quantifiable instability of a large language model may be detected and acted upon.

### SUMMARY

One or more embodiments provide for a method. The method includes applying a test large language model to a test input to generate a test output. The method also includes applying an encoding model to the test input to generate an encoded test input. The method also includes applying the encoding model to the test output to generate an encoded test output. The method also includes applying a cluster assignment model to a combination of the encoded test input, the encoded test output, and a set of clusters. Applying the cluster assignment model identifies an input cluster to which the encoded test input belongs and an output cluster to which the encoded test output belongs. The input cluster is one of the set of clusters. The output cluster is one of the set of clusters. The method also includes applying a comparison model to the input cluster and the output cluster to identify a relationship between the input cluster and the output cluster and to determine whether the relationship is one of multiple pre-existing relationships among the clusters. The method also includes responsive to the relationship failing to match at least one of the pre-existing relationships, returning a result.

One or more embodiments provide for another method. The method includes applying a stable large language model to past inputs to generate past outputs. The method also includes applying an encoding model to the past inputs to generate past encoded inputs. The method also includes applying the encoding model to the past outputs to generate past encoded outputs. The method also includes applying a clustering model to the past encoded inputs and the past encoded outputs to generate clusters. The method also includes applying a mapping model to the clusters to generate mapping data defining mappings among the clusters. The method also includes determining pre-existing relationships among the clusters from the mappings.

One or more embodiments also provide for a system. The system includes a processor and a data repository in communication with the processor. The data repository stores a test input and a test output. The data repository also stores an encoded test input and an encoded test output and multiple clusters. The data repository also stores an input cluster and an output cluster, each comprising one of the clusters. The data repository also stores a relationship between the input cluster and the output cluster. The data repository also stores pre-existing relationships among the clusters and a result. The system also includes a test large language model executable by the processor to generate the test output from the test input. The system also includes an encoding model executable by the processor to generate the encoded test input and the encoded test output. The system also includes a cluster assignment model executable by the processor to a combination of the encoded test input, the encoded test output, and the clusters. The cluster assignment model, when executed, identifies the input cluster to which the encoded test input belongs and the output cluster to which the encoded test output belongs. The system also includes a comparison model executable by the processor to identify the relationship between the input cluster and the output cluster and to determine whether the relationship is one of the pre-existing relationships among the clusters. The system also includes a server controller executable by the processor to return a result, responsive to the relationship failing to match at least one of the pre-existing relationships.

Other aspects of one or more embodiments will be apparent from the following description and the appended claims.

### BRIEF DESCRIPTION OF DRAWINGS

FIG. 1A and FIG. 1B show a computing system for detection and remediation of instabilities in large language models, in accordance with one or more embodiments.

FIG. 2A and FIG. 2B show flowcharts of methods useful in detection and remediation of instabilities in large language models, in accordance with one or more embodiments.

FIG. 3A, FIG. 3B, FIG. 3C, FIG. 3D, FIG. 3E, and FIG. 3F show data flows useful in detection and remediation of instabilities in large language models, in accordance with one or more embodiments.

FIG. 4 shows an example of a graphical user interface usable in a system for detection and remediation of instabilities in large language models, in accordance with one or more embodiments.

FIG. 5A and FIG. 5B shows an example of a computing system and network environment useable to implement the system of FIG. 1A and FIG. 1B, in accordance with one or more embodiments.

Like elements in the various figures are denoted by like reference numerals for consistency.

### DETAILED DESCRIPTION

One or more embodiments are directed to detection and remediation of instabilities in large language models. As indicated above, large language models have a tendency to drift, and may become more prone to hallucination over time. However, many processes may automatically use the output of large language models to generate other processes (e.g., a chatbot may use the output of a large language model to provide automated answers to an online user who supplies input text queries to the chatbot). In such cases, it may be undesirable or impractical to detect the likelihood of large language model hallucination because a computer scientist does not or cannot monitor all inputs and outputs of the large language model. For this reason, it is desirable not only to detect automatically an actual instance of machine learning model hallucination, but also to quantify the amount of machine learning model drift. In this manner, when a machine learning model drifts more than a pre-determined amount, an alert may be generated, and subsequently the machine learning model may be retrained or replaced.

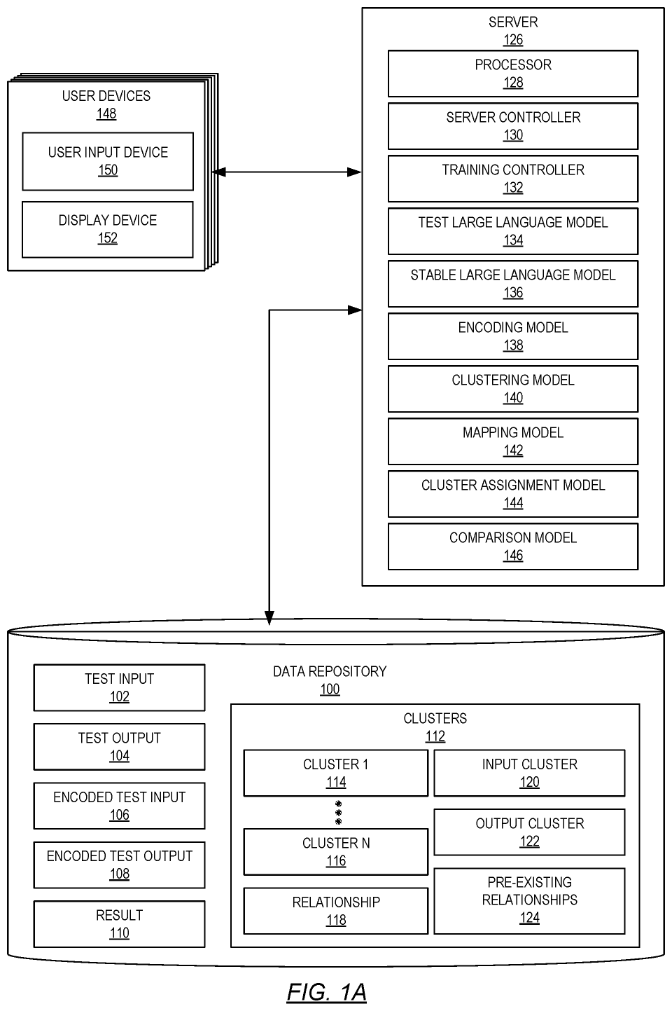

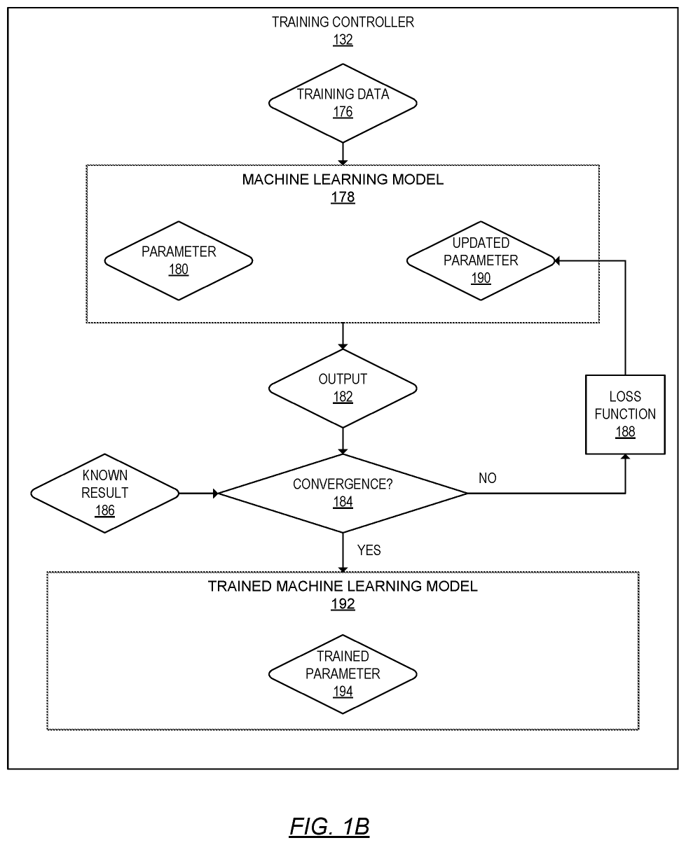

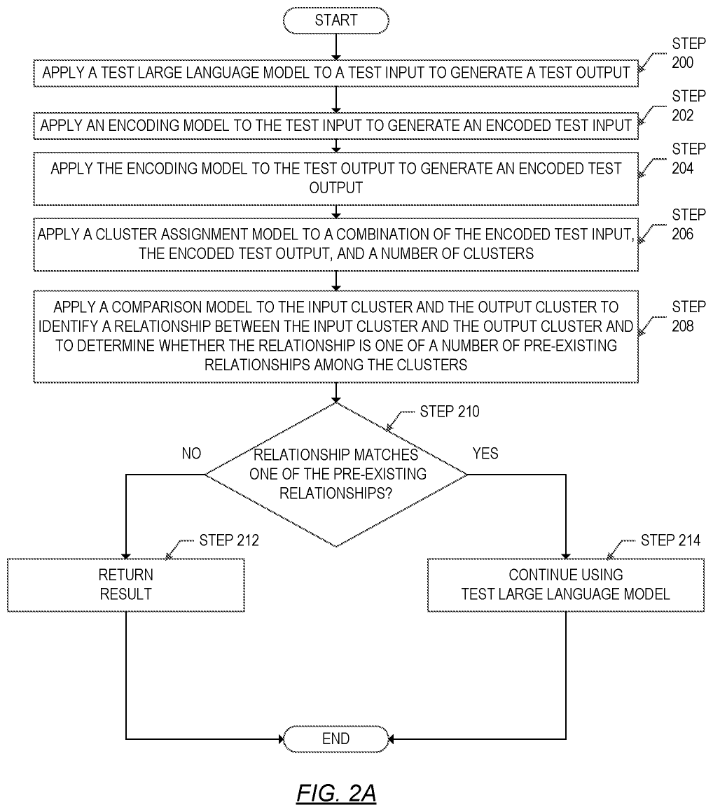

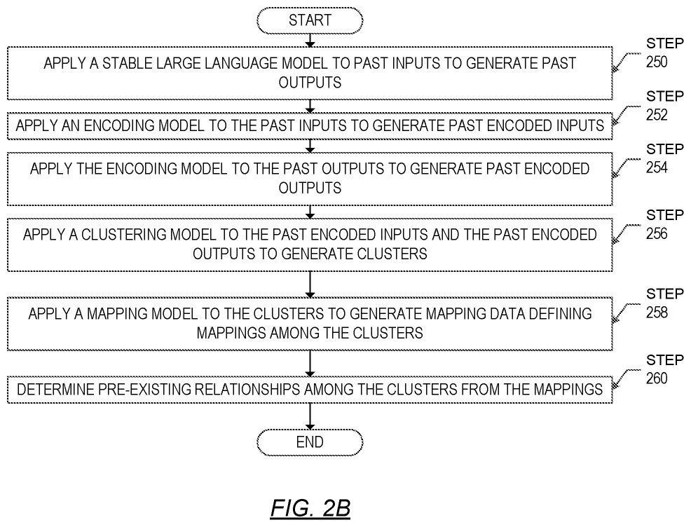

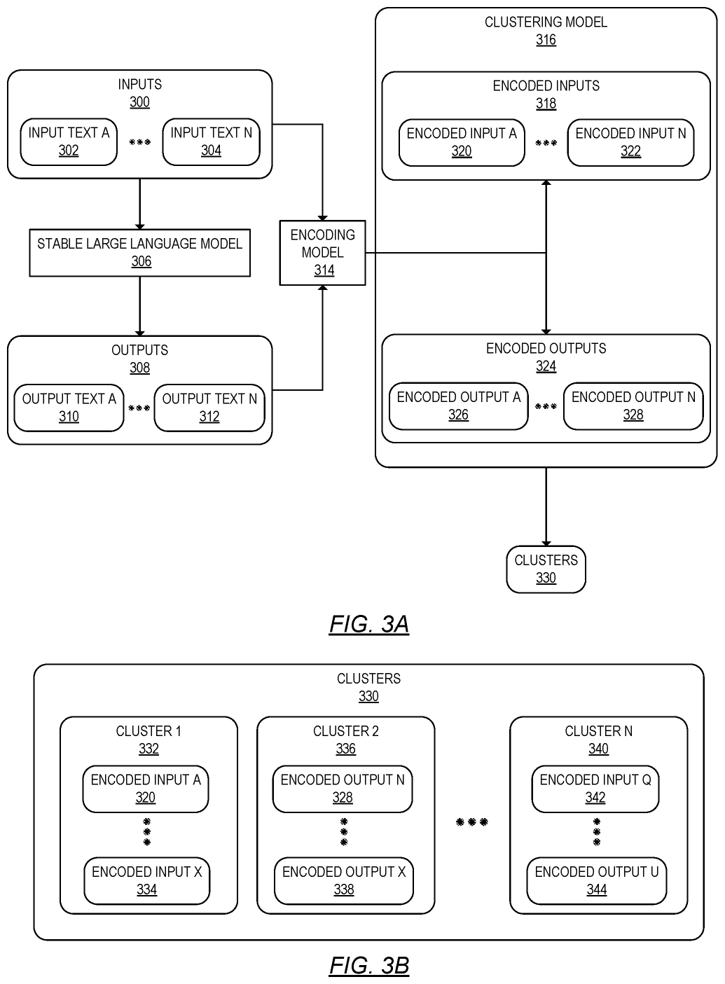

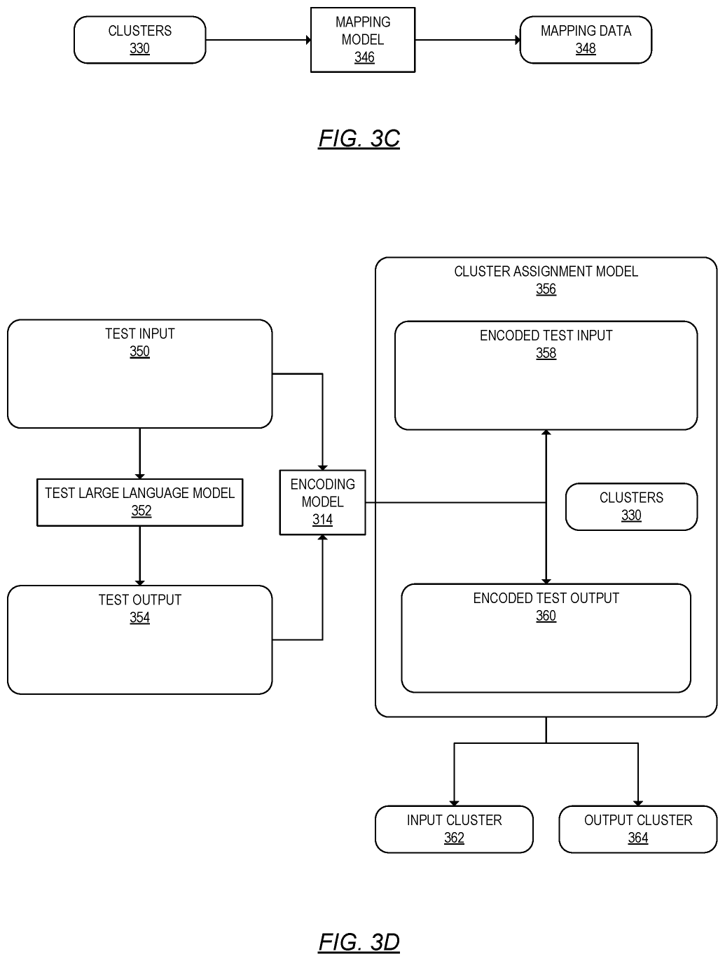

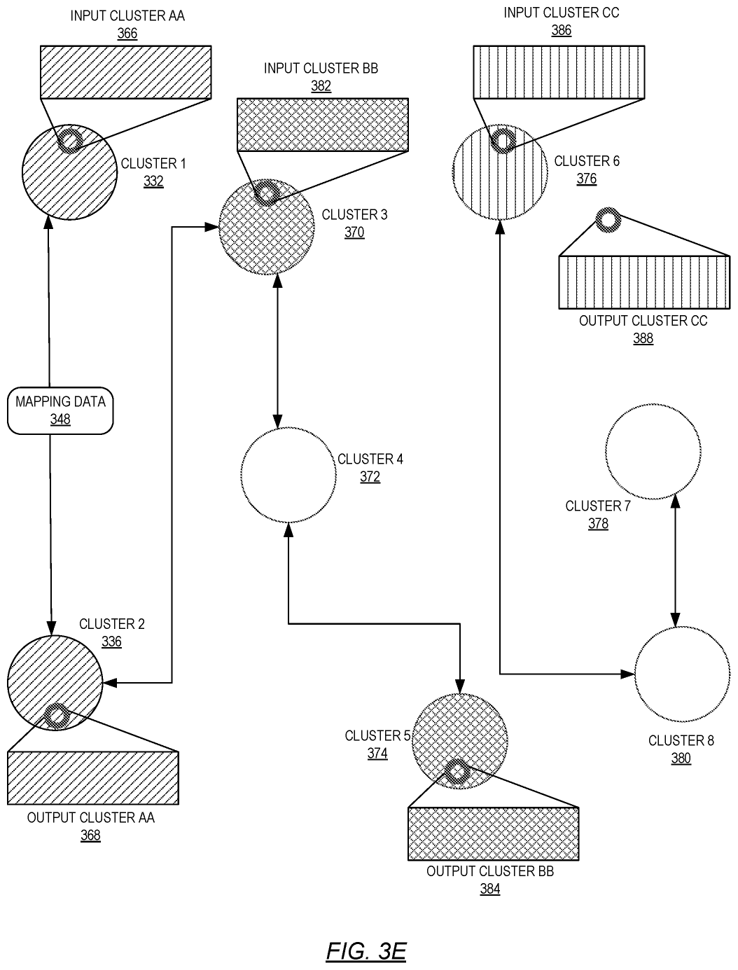

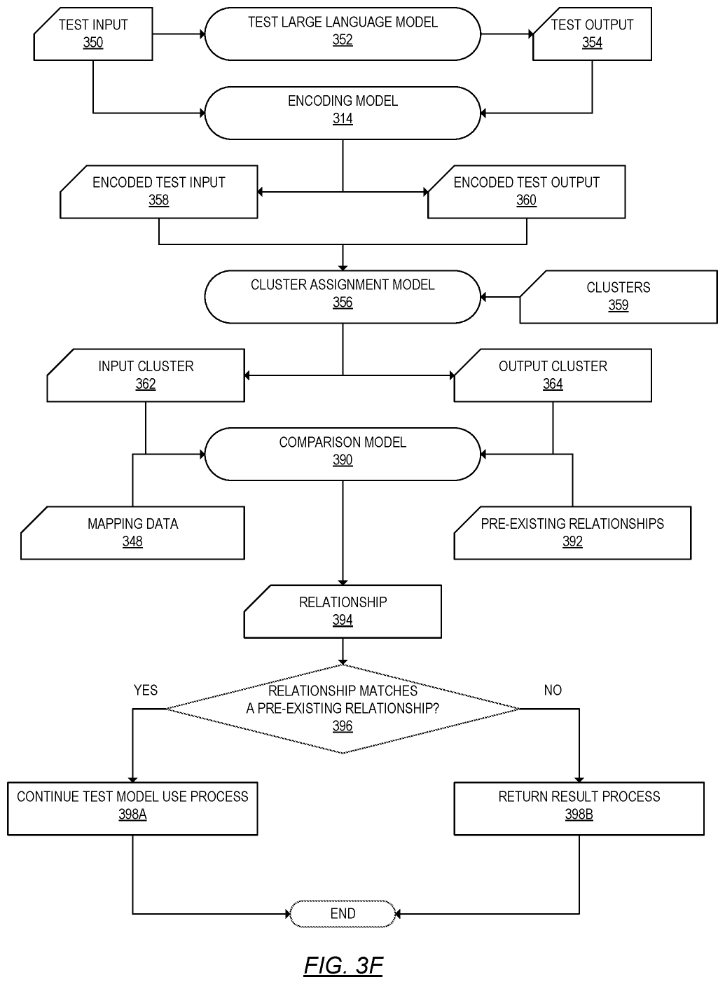

As indicated above, one or more embodiments provide methods and systems for detecting and remediating instabilities in large language models (e.g., detecting large language model drift). FIG. 2A describes the method of detection of large language model instabilities, and FIG. 2B describes a method of preparing the system of FIG. 1A for detection of large language model instabilities. FIG. 3A through FIG. 3F show exemplary data flows preparing a system to detect large language model instabilities, and then detecting large language model instabilities.

A brief summary of one or more embodiments is now presented. The large language model that is under observation is referred to as a test large language model. The test large language model is permitted to change over time, and thus may be retrained, refined, or otherwise adjusted as the test large language model is used. Another large language model, a stable large language model, is also maintained, but is not permitted to be retrained, refined, or otherwise adjusted. The stable large language model may be an original version of the test large language model in some cases.

As the test large language model operates over time, the same inputs that are provided to the test large language model are also provided to the stable large language model. The inputs and the outputs of the stable large language model are encoded (e.g., converted into embedded vectors) to generate a corpus of encoded inputs and corresponding encoded outputs.

The encoded inputs and the encoded outputs are clustered into a set of clusters. Each of the clusters tends to group encoded inputs with other encoded inputs, and to group encoded outputs with other encoded outputs, but it is possible that a cluster could include a combination of both encoded outputs and encoded inputs. The basis of clustering is semantic meaning. Thus, a encoded inputs are grouped with encoded inputs and encoded outputs that have a similar semantic meaning, as determined by a clustering algorithm.

A mapping model is then applied to the clusters. The mapping model is software, and may be another machine learning model, which generates mapping data. The mapping data specifies relationships among the clusters, with respect to how a given encoded input and a corresponding given encoded output are assigned to clusters. For example, it will be common that if a new input is determined to be in Cluster A, then it may be observed that the corresponding new output will be determined to be in Cluster B. Thus, Cluster A and Cluster B may be said to have a relationship. The mapping data specifies the relationships among the various clusters in the set of clusters.

After generating the mapping data, the preparation phase is complete. Next, a monitoring phase may begin in which a test large language model is monitored for drift.

During the monitoring phase, a new test input is provided to the test large language model, which generates a test output. The test input and the test output are encoded. A cluster assignment model is applied to the clusters, the encoded test input, and the encoded test output. The cluster assignment model determines the specific cluster (of the available set of clusters) to which the encoded test input is assigned. The assigned cluster is referred-to as an input cluster (though note that the input cluster is not necessarily input to another process, but rather the input cluster is the name assigned to the cluster to which the encoded test input is assigned).

Similarly, the cluster assignment model determines the specific cluster (of the available set of clusters) to which the encoded test output is assigned. The assigned cluster is referred-to as an output cluster (though note that the output cluster is not necessarily output from another process, but rather the output cluster is the name assigned to the cluster to which the encoded test output is assigned).

A comparator model is applied to the input cluster, the output cluster, and the mapping data to output the relationship between the input cluster and the output cluster. The relationship may be compared to a number of pre-determined relationships that are defined by the mapping data, thereby forming a quantified evaluation of the drift of the large language model. For example, if the relationship between the input cluster and the output cluster is one of a number of pre-determined relationships that are defined by the mapping data, then a prediction is returned that the test large language model is performing correctly (e.g., is not yet subject to an unacceptable quantified drift). However, if the relationship between the input cluster and the output cluster is not one of a number of pre-determined relationships that are defined by the mapping data, then a prediction may be returned that the test large language model is unstable (e.g., the large language model may have been subject to an unacceptable drift). In response to the prediction of large language model instability, the test large language model may be retrained, replaced, or only monitored, or some other remedial action may be taken with respect to the test large language model.

Attention is now turned to the figures. FIG. 1A shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a test input (102). The test input (102) is text that is input to a test large language model (134) (defined below). The term “text,” as used herein, includes alphanumeric test and may include special characters in some embodiments.

The data repository (100) also stores a test output (104). The test output (104) is text that is output from the test large language model (134) when the test large language model (134) is applied to the test input (102).

The data repository (100) also stores an encoded test input (106). The encoded test input (106) is the output of an encoding model (138) (defined below) when applied to the test input (102). Because the encoding model (138) converts text input into a vector data structure, the encoded test input (106) is the test input (102) in the form of a vector data structure (which may be referred to as a vector). For example, the vector may be composed of features that define a set of words. Each of features in the vector my have a value of “1” when one of the set words appears in the test input (102), and otherwise may have a value of “0”. However, the vector may take many different formats (e.g., the features may be letters, or other token definitions).

The data repository (100) also stores an encoded test output (108). The encoded test output (108) is the output of the encoding model (138) when applied to the test output (104). As with the encoded test input (106), the encoded test output (108) is the test output (104), but expressed in the form of a vector.

The data repository (100) also stores a result (110). The result (110) is the output of the comparison model (146) when the comparison model (146) is applied to the input cluster (120) and output cluster (122) (defined below). The result may take several different formats.

The result may be an alert. For example, the result may be an electronic message (e.g., text, email, private message, pop-up window, etc.) that is generated and displayed on a graphical user interface of a display device (152) of one of the user devices (148) (defined below).

The result may be a command to re-train the test large language model (134) (defined below). The result may be a command to replace the test large language model (134). The result may be to take some other action, such as cease use of the test large language model (134).

The data repository (100) also may store one or more clusters (112), such as cluster 1 (114) and cluster N (116), with possibly many clusters present in addition to the cluster 1 (114) and the cluster N (116). The clusters (112) are sets of encoded inputs (e.g., the encoded test input (106)) and encoded outputs (e.g., the encoded test output (108)) that are clustered together according to a clustering scheme.

The clustering scheme may be based on semantic meaning. For example, if the encoded test input (106) and the encoded test output (108) may be said to be in the same cluster when a clustering model (140) (defined below) determines that the encoded test input (106) and the encoded test output (108) are within a pre-determined semantic distance within each other. However, other clustering schemes are possible. For example, if the clustering model (140) is a K-means clustering model, then the clustering scheme is a K-means clustering scheme. Other clustering schemes may be used in different embodiments.

The clusters (112) are formed from encoded versions of the inputs to, and outputs from, a stable large language model (136) (defined below). For example, over time, inputs to and outputs from the stable large language model (136) may be saved and assembled into a corpus of encoded inputs and outputs.

In one or more embodiments, it may be expected that encoded test inputs may tend to cluster with one another, and that encoded test outputs may tend to cluster with one another. However, the clusters (112) are generated based on a combined corpus of all available encoded inputs and encoded outputs. Therefore, each of the clusters (112) may, or may not, include both encoded inputs and encoded outputs.

In use, the clusters (112) will include an input cluster (120) and an output cluster (122), and may include multiple instances of different input clusters or output clusters. The input cluster (120) is one of the clusters (112) to which the encoded test input (106) has been assigned during a use phase of one or more embodiments (e.g., see the example of FIG. 3F). The input cluster (120) is not a cluster of inputs (i.e., the input cluster (120) is not a cluster of multiple test inputs, for example). Rather, as indicated above, the input cluster (120) is a cluster that is selected from among the clusters (112) when assigning the encoded test input (106) to one of the clusters (112) (such as at step 206 of FIG. 2A).

Similarly, the output cluster (122) is one of the clusters (112) to which the encoded test output (108) has been assigned during a use phase of one or more embodiments (e.g., see the example of FIG. 3F). The output cluster (122) is not a cluster of outputs (i.e., the output cluster (122) is not a cluster of multiple test outputs, for example). Rather, as indicated above, the output cluster (122) is a cluster that is selected from among the clusters (112) when assigning the encoded test output (108) to one of the clusters (112) (such as at step 206 of FIG. 2A).

A relationship (118) exists between the input cluster (120) and the output cluster (122). In other words, the input cluster (120) and the output cluster (122) may be said to be in the relationship (118) because the encoded test input (106) was assigned to the input cluster (120) and the corresponding encoded test output (108) was assigned to the output cluster (122). A new relationship between the input cluster (120) and the output cluster (122) is formed each time the method of FIG. 2A is performed, as the relationship (118) is determined each time a new test input and a new test output is received.

A set of pre-existing relationships (124) exists among the clusters (112). The clusters (112) are relationships of two or more clusters among the clusters (112) that have been previously determined to be related to each other when performing past clustering operations of past encoded test inputs and past encoded test outputs.

For example, over time, many different instances of test inputs and test outputs are encoded into encoded test inputs and encoded test outputs. Over time, the encoded test inputs are assigned to ones of the clusters (112) and encoded test outputs also are assigned to ones of the clusters (112). Over time, relationships among the clusters (112) may be observed empirically, or determined automatically. For example, an observation may be made that when the encoded test input (106) is assigned to cluster 1 (114), then the most likely cluster to which the encoded test output (108) will be assigned will be the cluster N (116). In this example, the cluster 1 (114) is the input cluster (120) and the cluster N (116) is the output cluster (122). Thus, in this example, the cluster 1 (114) and the cluster N (116) may be said to be one of the pre-existing relationships (124).

An example of the pre-existing relationships (124), as well as an example of the relationship (118) between particular instances of the encoded test input (106) and the encoded test output (108), is shown in FIG. 3E. FIG. 3E also shows how the relationship (118) may be compared to the pre-existing relationships (124).

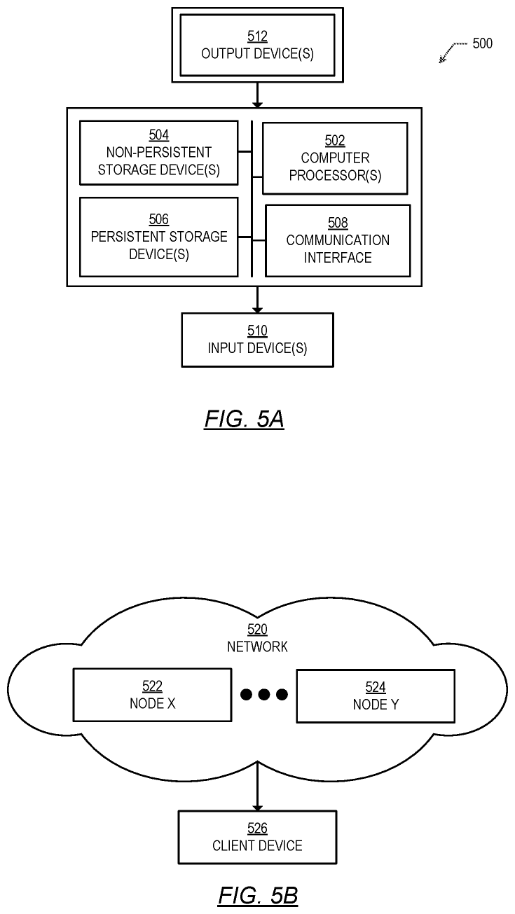

The system shown in FIG. 1A also may include other components. For example, the system shown in FIG. 1A also may include a server (126). The server (126) is one or more computing systems, possibly operating in a distributed computing environment. An example of the server (126) may be the computing system (500) shown in FIG. 5A.

The server (126) includes a processor (128). The processor (128) is one or more hardware or virtual processors which may execute one or more controllers, software applications, algorithms, or models as described herein. The processor (128) may be the computer processor(s) (502) in FIG. 5A.

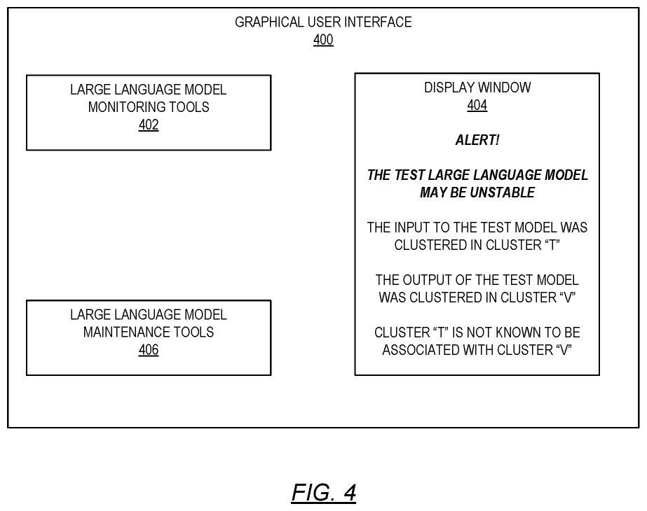

The server (126) may host a server controller (130). The server controller (130) is software or application specific hardware that, when executed by the processor, performs one or more operations described with respect to the method of FIG. 2A, the method of FIG. 2B, or the data flow shown in FIG. 3A through FIG. 3F. The server controller (130) also may coordinate operations of the various models hosted on the server, including the test large language model (134), the stable large language model (136), the encoding model (138), the clustering model (140), the mapping model (142), the cluster assignment model (144), and the comparison model (146). The server controller (130) also may implement the example shown in FIG. 4.

The server (126) also may host a training controller (132). The training controller (132) is software or application specific hardware which, when executed by the processor (128), trains one or more of the models controlled by the server controller (130) when the model is a machine learning model. The test large language model (134) and the stable large language model (136) are machine learning models. The encoding model (138), the clustering model (140), the mapping model (142), the cluster assignment model (144), and the comparison model (146) may be machine learning models, but also may be other types of algorithms for which training is not used. The architecture and operations of the training controller (132) is described with respect to FIG. 2B.

The server (126) also may host the test large language model (134). The test large language model (134) is a type of large language model. As indicated above, a large language model is a generative machine learning model (e.g. a neural network) programmed to take an input text and repeatedly predict a next word or token until an output text is generated. Large language models are termed “large” because large language models are trained on vast amounts of text data to learn possibly billions of parameters during training. More specifically, the test large language model (134) is the large language model that is currently in use for some other task (e.g., operating as a chatbot) and is being monitored as described by the method of FIG. 2A. The test large language model (134) may be updated over time (e.g., retrained or replaced), and thus the test large language model (134) may be termed a dynamic large language model.

The stable large language model (136) is also a large language model, as defined above. Initially, the stable large language model (136) may be the same model as the initial version of the test large language model (134). However, unlike the test large language model (134), the stable large language model (136) is not updated and is not replaced. Thus, the stable large language model (136) is said to be “stable” (i.e., the parameters, settings, training, and coding of the stable large language model (136) remain relatively constant with respect to the test large language model (134)). While it is possible to change or updated the stable large language model (136) from time to time, the stable large language model (136) is changed less frequently than the test large language model (134).

The server (126) also hosts an encoding model (138). The encoding model (138) is software or application specific hardware which, when executed by the processor (128), converts inputs and outputs (e.g., the test input (102) and the test output (104)) into encoded versions. Thus, for example, the encoding model (138) is programmed to convert the test input (102) into the encoded test input (106) and to convert the test output (104) into the encoded test output (108). In other words, the encoding model (138) converts inputs and outputs into vectors.

The encoding model (138) may be a machine learning model. For example, the encoding model (138) may be a machine learning model, and may be the stable large language model (136). The encoding model (138) may be some other type of machine learning model, or may be a non-machine learning model algorithm.

The server (126) also may host a clustering model (140). The clustering model (140) is software or application specific hardware which, when executed by the processor (128), clusters past encoded inputs and past encoded outputs in to the clusters (112). The clustering model (140) also may determine a cluster assignment for the encoded test input (106) in order to determine the input cluster (120). The clustering model (140) also may determine a cluster assignment for the encoded test output (108) in order to determine the output cluster (122).

The clustering model (140) may be a machine learning model, such as a K-means clustering model. However, the clustering model (140) also may be a density clustering model, a grid-based clustering model, a hierarchical clustering model, or other types of machine learning models. The clustering model (140) also may be a non-machine learning model algorithm programmed to cluster data.

The server (126) also may host a mapping model (142). The mapping model (142) is software or application specific hardware which, when executed by the processor (128), determines the pre-existing relationships (124) among the clusters (112). The mapping model (142) also may be programmed to determine the relationship (118) between the input cluster (120) and the output cluster (122).

The mapping model (142) also may be the clustering model (140) in some embodiments. However, the two models are separately named in order to more particularly define the functions of one or more embodiments. The mapping model (142) may also be some other type of machine learning model which determines relationships between clusters. The mapping model (142) also be a non-machine learning model algorithm that, for example, track the cluster assignments of each past encoded test input and past encoded output and establishes the pre-existing relationships (124) based on the most likely cluster assignment of a given test output for a cluster assignment of a given test input.

For example, encoded inputs are paired with ones of the encoded outputs (each encoded input is the encoded version of an input to the test large language model (134) and each encoded output is the encoded version of an corresponding output to the test large language model (134) based on that input). Thus, over time, the mapping model (142) may observe and store that, for 62% of encoded input-encoded output pairs, the input cluster is the cluster 1 (114) and the output cluster is the cluster N (116). Thus, the cluster 1 (114) and the cluster N (116) in this example are deemed to be in one of the pre-existing relationships (124).

The server (126) also may host a cluster assignment model (144). The cluster assignment model (144) is software or application specific hardware which, when executed by the processor (128), assigns the encoded inputs to one of the clusters (112) and likewise assigns the encoded outputs to the another of the clusters (112). Thus, the cluster assignment model (144) may assign the encoded test input (106) to the input cluster (120) and may assign the encoded test output (108) to the output cluster (122).

The cluster assignment model (144) may be the clustering model (140) in some embodiments. However, the two models are separately named in order to more particularly define the functions of one or more embodiments. The cluster assignment model (144) may also be some other type of machine learning model which assigns the encoded test input (106) and the encoded test output (108) to ones of the clusters (112). The cluster assignment model (144) also be a non-machine learning model algorithm.

The server (126) also hosts a comparison model (146). The comparison model (146) is software or application specific hardware which, when executed by the processor (128), compares the relationship (118) to the pre-existing relationships (124). Comparing the relationship (118) to the pre-existing relationships (124) is described with respect to FIG. 2A, step 208 and is exemplified in FIG. 3F at comparison model (390). The comparison model (146) may be a machine learning model, such as the clustering model (140). However, the comparison model (146) also may be a non-machine learning algorithm that checks whether the relationship (118) is one of the pre-existing relationships (124).

The system shown in FIG. 1A also may include other devices. For example, the user devices (148) may include one or more user input devices, such as the user input device (150). The user input devices are keyboards, mice, microphones, cameras, etc. with which a user may provide input to the user devices (148).

The user devices (148) may include one or more display devices, such as the display device (152). The display devices are monitors, televisions, touchscreens, etc. which may display information to a user.

The user in one or more embodiments may be a computer scientist or other technician. For example, the user may be a computer scientist or other technician that views the graphical user interface shown in FIG. 4.

Attention is turned to FIG. 1B, which shows the details of the training controller (132). The training controller (132) is a training algorithm, implemented as software or application specific hardware, that may be used to train one or more the machine learning models described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model is applied to unknown data in order to make predictions.

Some machine learning models may be applied to vector data structures. A vector is a computer-readable data structure. A vector may take the form of a matrix, an array, a graph, or some other data structure. However, a frequently used form of vector is a one by N matrix, where each cell of the matrix represents the value for one feature. A feature is a type of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1A may be stored in the form of one or more vectors. For example, the encoded test input (106) and the encoded test output (108) may be vectors. The clusters (112) may be represented as collections of such vectors, associated by a grouping organization (as explained above with respect to FIG. 1A).

Returning to the operation of the training controller (132), training starts with training data (176), and which may be expressed as a training data vector. In one or more embodiments, the training data (176) may be past encoded inputs, past encoded outputs, and clusters for which past pre-existing relationships are known. The training data (176) may be data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178) may be characterized as a program that has adjustable parameters. The program is capable of learning and recognizing patterns to make predictions. The output of the machine learning model may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is a output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model being used (supervised versus unsupervised machine learning), or may be pre-determined by a user (e.g., convergence occurs after a set number of training iterations, described below).

In the case of supervised machine learning, the convergence process (184) compares the output (182) to a known result (186). The known result (186) is stored in the form of labels for the training data. For example, the known result for a particular entry in an output vector of the machine learning model may be a known value, and that known value is a label that is associated with the training data.

Continuing the example of supervised machine learning model training, a determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

In the case of unsupervised machine learning, the convergence process (184) may be compared to the output (182) or to a prior output in order to determine a degree to which the current output changed relative to the immediately prior output or to the original output. Once the degree of changes fails to satisfy a threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188), but may be a scheme which attempts to guess how the parameter (180) may be changed so that the next execution of the machine learning model (178) using the training data (176) with the updated parameter (190) will have an output (182) that is more likely to result in convergence. (E.g., that the next execution of the machine learning model (178) is more likely to match the known result (186) (supervised learning), or which is more likely to result in an output that more closely approximates the prior output (one unsupervised learning technique), or which otherwise is more likely to result in convergence.)

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data (which may be in the form of an unknown data vector) for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

FIG. 2A and FIG. 2B show flowcharts of methods useful in detection and remediation of instabilities in large language models, in accordance with one or more embodiments. FIG. 2A shows a use-phase method in which a test large language model is monitored by a stable large language model. FIG. 2B shows a setup phase method in which a stable large language model determines the available corpus of clusters, and the pre-existing relationships among the clusters. The clusters and the pre-existing relationships determined by the method of FIG. 2B are used during the test phase of FIG. 2A. The methods of FIG. 2A and FIG. 2B may be implemented using the system of FIG. 1A, possibly using the computing system and network environment shown in FIG. 5A and FIG. 5B.

Turning first to FIG. 2A, step 200 includes applying a test large language model to a test input to generate a test output. The test large language model may be applied to a test input by supplying the test input to the test large language model. For example, a chatbot which is at least partially controlled by the test large language model may receive a text input from a remote user (e.g., a customer). In another example, the test large language model is applied to the input by supplying both the test input and a prompt to the large language model and then executing the large language model to generate the test output. A prompt is a set of instructions to the large language model which define constraints on how the large language model is to process the test input.

The test large language model is then applied to the text input by executing the test large language model on the text input. The resulting output of the test large language model is the test output. The test output also may be text. For example, if the test input is “I need help with reading my W-2 form,” then the test output may be, “I can help with that. Is there a specific part of the W-2 form you need help reading?”

Step 202 includes applying an encoding model to the test input to generate an encoded test input. Encoding the test input may be performed by applying a stable large language model to the test input. A prompt may specify instructions to the stable large language model that define the form of the output of the stable large language model. Thus, the prompt may instruct the stable large language model to convert the test input into a vector format. The result of executing the stable large language model in step 202 is to generate an encoded test input. In other words, the output of the stable large language model at step 202 is the encoded test input.

The encoded test input may be generated using other methods. For example, the test large language model or some other large language model could be used to generate the encoded test input. In another example, some other algorithm or machine learning model may be used to convert the test input into the encoded test input.

Step 204 includes applying the encoding model to the test output to generate an encoded test output. Encoding the test output may be performed by applying a stable large language model to the test output. A prompt may specify instructions to the stable large language model that define the form of the output of the stable large language model. Thus, the prompt may instruct the stable large language model to convert the test output into a vector format. The result of executing the stable large language model in step 204 is to generate an encoded test output. In other words, the output of the stable large language model at step 204 is the encoded test output.

The encoded test output may be generated using other methods. For example, the test large language model or some other large language model could be used to generate the encoded test output. In another example, some other algorithm or machine learning model may be used to convert the test output into the encoded test output.

Step 206 includes applying a cluster assignment model to a combination of the encoded test input, the encoded test output, and a set of available, pre-existing clusters. Applying the cluster assignment model identifies an input cluster to which the encoded test input belongs and an output cluster to which the encoded test output belongs. The input cluster may be one of the available, pre-existing clusters. The output cluster also may be one of the available, pre-existing clusters. While the input cluster and the output cluster may be assigned to new clusters, in many cases the input cluster and the output cluster will both be one of the available, pre-existing clusters.

The cluster assignment model may be a clustering model. The clustering model takes, as input, the encoded test input and the encoded test output, together with the available, pre-existing clusters. The pre-existing clusters may be determined according to the method of FIG. 2B.

The clustering model outputs a cluster assignment for the encoded test input and the encoded test output. In each case, the cluster assignment may be to one of the available pre-existing clusters, or may be a new cluster newly created for the encoded test input or the encoded test output.

Step 208 includes applying a comparison model to the input cluster and the output cluster to identify a relationship between the input cluster and the output cluster and to determine whether the relationship is one of a set of pre-existing relationships among the available, pre-existing clusters. The input cluster and the output cluster automatically have a relationship, as the test input has a relationship with the test output by virtue of being associated with one execution of the test large language model. In other words, the relationship between the input cluster and the output cluster is that the two clusters are both associated with one execution of the test large language model on a test input.

However, what occurs in step 208 is that a determination is made whether the relationship between the input cluster and the output cluster is one of the pre-existing relationships previously determined to exist among the various clusters in at least some clusters of the set of clusters. An example of the comparison is shown in FIG. 3E.

Step 210 includes determining if the relationship (between the input cluster and the output cluster) matches one of the pre-existing relationships among at least some of the available-preexisting clusters. Again, an example of the determination is shown in FIG. 3E.

If not (a “no” determination at step 210), no pre-existing relationship matches the relationship (between the input cluster and the output cluster). Thus, the relationship is unique among all previously-determined relationships among the clusters. Responsive to the relationship failing to match at least one of the pre-existing relationships, step 212 includes returning a result.

The result, at step 212, may be returned by generating an alert. The alert may be presented to a user via an electronic message (text, email, instant message, pop-up window, etc.) displayable on a graphical user interface. The result may be a command to retrain the test large language model. The result may be a command to replace the test large language model with a new large language model. The result may be a command to pause execution of the test large language model. The result may be to take some other computer-implemented action.

In a specific example, returning the result may include adjusting, responsive to the relationship failing to match the at least one of the pre-existing relationships, a training parameter of the test large language model to generate an adjusted training parameter. Then, the test large language model may be retrained using the adjusted training parameter. The procedure for training the test large language model is described in FIG. 1B.

In another specific example, returning the result may include adjusting, responsive to the relationship failing to match the at least one of the pre-existing relationships, adjusted training data. Then, the test large language model may be retrained using the adjusted training data. Again, the procedure for training the test large language model is described in FIG. 1B.

The test large language model also may be retrained based on a combination of changing the training data and on adjusted training parameters. The test large language model may be retrained by adding new training data to the training data set and then retraining the model. Other retraining procedures are also possible.

The method of FIG. 2A may be varied. For example, one or more steps of the method of FIG. 2B may be added as steps taken before step 200. In this case, the same comparison model may determine both the pre-existing relationships based on mapping data and the clusters (during a setup phase such as in FIG. 2B), and also compare the relationship (between the encoded test input and the encoded test output) to the pre-existing relationships (during a use phase such as in FIG. 2A).

Returning to step 210, if the relationship (between the input cluster and the output cluster) does not match one of the pre-existing relationships among at least some of the available-preexisting clusters (a “yes” determination at step 210) then the relationship is not a unique relationship. In this case, the test large language model is determined to be operating as expected. Thus, at step 214, the test large language model may continue to be used without modification (e.g., as a chatbot, as a text processing model, etc.

In an embodiment, the method may terminate thereafter. However, in another embodiment, the stable large language model may continue to monitor the test large language model. In this case, instead of the method of FIG. 2A terminating after step 212 or step 214, the method of FIG. 2A may return to step 200 and repeat when a new test input is received.

Attention is now turned to FIG. 2B. FIG. 2B may be characterized as a setup phase which is performed before the method of FIG. 2A. The method of FIG. 2B may be used to determine the pre-existing clusters and the relationships among the pre-existing clusters, both of which are used during the method of FIG. 2A, as explained above.

Step 250 includes applying a stable large language model to past inputs to generate past outputs. Applying the stable large language model to past inputs and past outputs is similar to step 200 of FIG. 2A, except that a different large language model is used, and different inputs and outputs are generated.

Step 252 includes applying an encoding model to the past inputs to generate past encoded inputs. Step 254 includes applying the encoding model to the past outputs to generate past encoded outputs. Applying the encoding model to past inputs and past outputs is similar to step 202 and step 204 of FIG. 2A, excepting that the inputs and outputs are different.

Step 256 includes applying a clustering model to the past encoded inputs and the past encoded outputs to generate clusters. The clusters are generated as the output of a clustering model with the combined corpus of past encoded input and past encoded outputs being the input to the clustering model. The clusters generated are the pre-existing clusters described with respect to FIG. 2A. The clusters generated thus form a corpus of pre-existing clusters.

Step 258 includes applying a mapping model to the clusters to generate mapping data defining mappings among the clusters. The mapping model examines each pair of encoded input and encoded output from a single execution of the stable large language model at step 250 and determines a corresponding input cluster and a corresponding output cluster for the pair. As a result, the mapping model generates mapping data. The mapping data defines a proportion of encoded inputs that are assigned to a first cluster that also have at least a preponderance of corresponding encoded outputs that are assigned to a second cluster.

Step 260 includes determining pre-existing relationships among the clusters from the mappings. The mapping model may perform the determination, as described above at step 258. The determining process at step 260, or at 258, may include determining the pre-existing relationships among up to all the encoded inputs and up to all of the encoded outputs with respect to up to all the clusters determined at step 256. Thus, when the mapping model is finished executing, the mapping data includes a set of pre-existing relationships among the pre-existing clusters.

By way of illustration, the procedure of applying the mapping model is exemplified in FIG. 3E. In the example of FIG. 3E, the mapping data is the data that defines the pre-existing relationships among the clusters, as shown by the arrows between the clusters.

The method of FIG. 2B may be varied. For example, the method of FIG. 2A may be executed after step 260 of the method of FIG. 2B. Accordingly, as mentioned above, the method of FIG. 2B may be referred to as a setup phase of one or more embodiments, and the method of FIG. 2A may be referred to as a use phase of one or more embodiments.

While the various steps in the flowcharts of FIG. 2A and FIG. 2B are presented and described sequentially, at least some of the steps may be executed in different orders, may be combined or omitted, and at least some of the steps may be executed in parallel. Furthermore, the steps may be performed actively or passively.

FIG. 3A, FIG. 3B, FIG. 3C, FIG. 3D, FIG. 3E, and FIG. 3F show data flows useful in detection and remediation of instabilities in large language models, in accordance with one or more embodiments. The data flows shown in FIG. 3A through FIG. 3F may be executed using the system shown in FIG. 1A, possibly using the computing system and network environment shown in FIG. 5A and FIG. 5B. In FIG. 3A through FIG. 3F common reference numerals refer to common objects having common definitions or functions.

Attention is first turned to FIG. 3A, which shows an example of generating the pre-existing clusters at step 256 of FIG. 2B. A set of inputs (300), such as the input text A (302) up to many input texts as indicated by the input text N (304), is provided as input to the stable large language model (306). The stable large language model (306) generates the outputs (308). Each of the inputs has a corresponding output. Thus, the output text A (310) corresponds to the input text A (302) and the output text N (312) corresponds to the input text N (304).

The inputs (300) and the outputs (308) are provided as input to the encoding model (314). The output of the encoding model (314) are a set of the encoded inputs (318) and a set of the encoded outputs (324). Each of the inputs (300) and the outputs (308) are individually encoded into vectors. Thus, the input text A (302) corresponds to the encoded input A (320), the encoded input N (322) corresponds to the input text N (304), the encoded output A (326) corresponds to the output text A (310), and the encoded output N (328) corresponds to the output text N (312).

In the example of FIG. 3A, the entire corpus of the encoded inputs (318) and the encoded outputs (324) is combined and provided as input to the clustering model (316). The output of the clustering model (316) is the clusters (330), which may be characterized as the pre-existing clusters.

Attention is now turned to FIG. 3B, which shows and example of the nature of the clusters (330). The clusters (330) in FIG. 3B are the same as the clusters (330) in FIG. 3A. In FIG. 3B, three clusters are shown: the cluster 1 (332), the cluster 2 (336), and the cluster N (340).

The cluster 1 (332) includes the encoded input A (320) and the encoded input X (334), among possibly other encoded inputs. In the example, the cluster 1 (332) includes only encoded inputs clustered into the cluster 1 (332).

The cluster 2 (336) includes the encoded output N (328) and the encoded output X (338), among possibly other encoded outputs. In the example, the cluster 2 (336) includes only encoded outputs clustered into the cluster 2 (336).

The cluster N (340) includes the encoded input Q (342) and the encoded output U (344), among possibly other encoded outputs and encoded inputs. In the example, the cluster N (340) includes both encoded inputs and encoded outputs clustered into the cluster N (340).

FIG. 3C shows a data flow for generating the mapping data (348). The clusters (330) are provided to the mapping model (346) as input. The output of the mapping model (346) is the mapping data (348). The generation of the mapping data (348) may be performed as described with respect to FIG. 2B. Briefly, the mapping model (346) examines the cluster assignments of the various encoded inputs and encoded outputs, and identifies patterns of the clustering assignments. For example, it may be observed that the cluster 1 (332) (of FIG. 3B) is frequently associated with the cluster 2 (336) (of FIG. 3B) when the clustering of each of the encoded input-output pairs is observed. Thus, a relationship is observed between the cluster 1 (332) and the cluster 2 (336), and that relationship is added as data to the mapping data (348).

FIG. 3D shows generation of the input cluster (362) and the output cluster (364). FIG. 3D corresponds to step 200, step 202, and step 204 of FIG. 2A.

The test input (350) is provided as input to the test large language model (352). When executed, the test large language model (352) generates the test output (354). Then, the test input (350) and the test output (354) are provided as input (either in parallel or serially) to the encoding model (314). The output of the encoding model (314) is the encoded test input (358) and the encoded test output (360).

The encoded test input (358) and the encoded test output (360) are provided as input to the cluster assignment model (356) (either in parallel or serially). In addition, the clusters (330) are provided as input. Thus, the cluster assignment model (356) is applied to the encoded test input (358) and the clusters (330) to generate the input cluster (362). Likewise, the cluster assignment model (356) is applied to the test input (350) and the clusters (330) to generate the output cluster (364). Again, the input cluster is cluster to which the encoded test input (358) is assigned. Similarly, the output cluster (364) is the cluster to which the encoded test output (360) is assigned.

FIG. 3E shows an integrated example of pre-existing clusters, relationships among clusters, input clusters, and output clusters. Again, each of the clusters are groups of encoded inputs (the encoded inputs being encoded versions of text inputs to a stable large language model), encoded outputs (the encoded outputs being encoded versions of text outputs from the stable large language model), or combinations thereof. The groupings of the encoded inputs and encoded outputs (i.e., the clusters) are determined by the clustering model.

In the example of FIG. 3E, eight clusters are shown, the cluster 1 (332), the cluster 2 (336), the cluster 3 (370), the cluster 4 (372), the cluster 5 (374), the cluster 6 (376), the cluster 7 (378), and the cluster 8 (380). Pre-existing relationships among the clusters have been determined by a mapping model. The pre-existing relationships are defined by the mapping data (348). The mapping data (348) is represented by the arrows between various clusters shown in FIG. 3E.

Thus, the cluster 1 (332) is known to have a relationship with the cluster 2 (336). The cluster 1 (332) also is known to have a relationship with the cluster 3 (370). Thus, it may be seen that some clusters may have relationships with multiple clusters. More generally, the clusters may have a many-to-many relationship with each other. However, some clusters may have a single relationships with one other cluster. In some cases, such as described below, a cluster may have no relationship with another cluster.

Continuing the example, the cluster 3 (370) has a relationship with the cluster 4 (372). The cluster 4 (372) also has a relationship with the cluster 5 (374). However, relationships are not indirectly defined. Thus, for example, there is no relationship between the cluster 3 (370) and the cluster 5 (374), even though both clusters are related to the cluster 4 (372). In like manner, the cluster 6 (376) and the cluster 7 (378) each have a relationship with the cluster 8 (380), but the cluster 6 (376) does not have a relationship with the cluster 7 (378).

Bearing in mind the above relationships among the clusters, three examples are now provided for step 206 (applying a clustering model), step 208 (applying a comparison model), and step 210 (determining a relationship match) of FIG. 2A. Each of the examples is defined by a common hashing pattern shown in the shapes of FIG. 3E. Thus, for example, the cluster 1 (332), the cluster 2 (336), the input cluster AA (366), and the output cluster AA (368) are part of a first example. The cluster 3 (370), the cluster 5 (374), and the input cluster BB (382) are part of a second example. The cluster 6 (376), the input cluster CC (386), and the output cluster CC (388) are part of a third example.

In the first example, step 200, step 202, and step 204 of FIG. 2A have been executed already. Thus, a large language model was applied to a test input to generate a test output, and the encoded test input and encoded test output are now available. More specifically, the encoded test input is the bold circle shown within the cluster 1 (332) and the encoded test output is the bold circle shown within the cluster 2 (336). Because the encoded test input is within (i.e., assigned to) the cluster 1 (332), the cluster 1 (332) is characterized as the input cluster for the encoded test input. Thus, the input cluster AA (366) is the cluster 1 (332). However, the input cluster AA (366) is shown as a separate entity for purposes of clarity of description.

Similarly, because the encoded test output is within (i.e. assigned to) the cluster 2 (336), the output cluster AA (368) is characterized as the output cluster for the encoded test output. Thus, the output cluster AA (368) is the cluster 2 (336). However, the output cluster AA (368) is shown as a separate entity for purposes of clarity of description.

The determination of the input cluster AA (366) and the output cluster AA (368) is an example of step 206 of FIG. 2A (the assignment of the encoded test input and encoded test output to clusters). Now, example 1 in FIG. 3E demonstrates step 208 of FIG. 2A (the comparison of the relationship between input cluster and the output cluster to the pre-existing relationships). Because the encoded test input and the encoded test output are derived from a single execution of the test large language model, it is known that the input cluster AA (366) is in a relationship with the output cluster AA (368)—at least with respect to the specific pair of the encoded test input and the encoded test output. However, a determination is to be made whether the specific relationship matches one of the pre-existing relationships. Again, the pre-existing relationships among the clusters, shown by the arrows in FIG. 3E, were previously determined the mapping model and are stored as the mapping data (348).

As may be seen visually by the arrow connecting the cluster 1 (332) and the cluster 2 (336), a pre-existing relationship exists between the cluster 1 (332) and the cluster 2 (336). Additionally, for the specific pair of the encoded test input and the encoded test output, the input cluster AA (366) is the cluster 1 (332) and the output cluster AA (368) is the cluster 2 (336). Thus, the specific cluster assignment relationship between the encoded test input and the encoded test output matches the pre-existing relationship between the cluster 1 (332) and the cluster 2 (336).

Because a match exists between the relationship between clusters for the specific encoded test input and encoded test output and at least one of the pre-existing relationships among the clusters generally, the relationship may be referred to an expected or normal relationship. Thus, in the example 1, the test large language model is determined to be operating normally (within acceptable parameters). Hence, no change is needed with respect to the test large language model, and operation of the test large language model may continue accordingly.

In the second example, step 200, step 202, and step 204 of FIG. 2A have been executed already. Thus, a large language model was applied to a test input to generate a test output, and the encoded test input and encoded test output are now available. More specifically, the encoded test input is the bold circle shown within the cluster 3 (370) and the encoded test output is the bold circle shown within the cluster 5 (374).

Because the encoded test input is within (i.e., assigned to) the cluster 3 (370), the cluster 3 (370) is characterized as the input cluster for the encoded test input. Thus, the input cluster BB (382) is the cluster 3 (370). However, the input cluster BB (382) is shown as a separate entity for purposes of clarity of description.

Similarly, because the encoded test output is within (i.e. assigned to) the cluster 5 (374), the output cluster BB (384) is characterized as the output cluster for the encoded test output. Thus, the output cluster BB (384) is the cluster 5 (374). However, the output cluster BB (384) is shown as a separate entity for purposes of clarity of description.

The determination of the input cluster BB (382) and the output cluster BB (384) is an example of step 206 of FIG. 2A (the assignment of the encoded test input and encoded test output to clusters). Now, example 2 in FIG. 3E demonstrates step 208 of FIG. 2A (the comparison of the relationship between input cluster and the output cluster to the pre-existing relationships).

Because the encoded test input and the encoded test output are derived from a single execution of the test large language model, it is known that the input cluster BB (382) is in a relationship with the output cluster BB (384)—at least with respect to the specific pair of the encoded test input and the encoded test output. However, a determination is to be made whether the specific relationship matches one of the pre-existing relationships. Again, the pre-existing relationships among the clusters, shown by the arrows in FIG. 3E, were previously determined the mapping model and are stored as the mapping data (348).

As may be seen visually by the arrows connecting the clusters, no direct relationship exists between the cluster 3 (370) and the cluster 5 (374). The fact that both of the clusters are also in relationship with the cluster 4 (372) is not sufficient to establish a relationship between the cluster 3 (370) and the cluster 5 (374) in this example. Thus, the specific cluster assignment relationship between the encoded test input and the encoded test output does not match the pre-existing relationships present among the eight clusters shown in FIG. 3E. As shown visually, because the input cluster BB (382) and the output cluster BB (384) are not in clusters that have a pre-existing relationship, there is no match between the relationship (between the clusters assigned for encoded test input and the encoded test output) and the pre-existing relationships.

Because a match does not exist between the relationship between clusters for the specific encoded test input and encoded test output and at least one of the pre-existing relationships among the clusters generally, the relationship may be referred to an unexpected or abnormal relationship. Thus, in the example 2, the test large language model is determined to be operating outside acceptable parameters, or is behaving unexpectedly.

Hence, a result is generated. The result may be to alert a user. The result may be to re-train the test large language model using new parameters, new training data, or a combination thereof. The result may be to replace the test large language model. The result may be to pause execution of the test large language model with respect to some other function for which the test large language model is being used. Other results may be generated.

In the third example, step 200, step 202, and step 204 of FIG. 2A have been executed already. Thus, a large language model was applied to a test input to generate a test output, and the encoded test input and encoded test output are now available. More specifically, the encoded test input, in this example, is the bold circle shown within the cluster 6 (376). In turn, the encoded test output is the bold circle shown by itself (not associated with any of the eight clusters in FIG. 3E). The encoded test output is marked by the output cluster CC (388).

Because the encoded test input is within (i.e., assigned to) the cluster 6 (376), the cluster 6 (376) is characterized as the input cluster for the encoded test input. Thus, the input cluster CC (386) is the cluster 6 (376). However, the input cluster CC (386) is shown as a separate entity for purposes of clarity of description.

However, the clustering model assigned the output cluster CC (388) to a new cluster. In the third example, encoded test output forms a new, ninth cluster. Namely, the encoded test output is the output cluster CC (388). The encoded test output is thus the sole member of the new, ninth cluster in the third example.

The determination of the input cluster CC (386) and the output cluster CC (388) is an example of step 206 of FIG. 2A (the assignment of the encoded test input and encoded test output to clusters). Now, example 3 in FIG. 3E demonstrates step 208 of FIG. 2A (the comparison of the relationship between input cluster and the output cluster to the pre-existing relationships).

Because the encoded test input and the encoded test output are derived from a single execution of the test large language model, it is known that the input cluster CC (386) is in a relationship with the output cluster CC (388)—at least with respect to the specific pair of the encoded test input and the encoded test output. However, a determination is to be made whether the specific relationship matches one of the pre-existing relationships. Again, the pre-existing relationships among the clusters, shown by the arrows in FIG. 3E, were previously determined the mapping model and are stored as the mapping data (348).

As may be seen visually by the arrows connecting the clusters, the output cluster CC (388) is not in a previous relationship with any of the other eight clusters, because the output cluster CC (388) is a new, ninth cluster. Thus, it is not possible for the relationship between input cluster CC (386) (the cluster to which the encoded test input was assigned) and the output cluster CC (388) (the cluster to which the encoded test output was assigned) to match any of the pre-existing relationships indicated by the arrows in FIG. 3E.

Because a match does not exist between the relationship between clusters for the specific encoded test input and encoded test output and at least one of the pre-existing relationships among the clusters generally, the relationship may be referred to an unexpected or abnormal relationship. Thus, in the example 3, the test large language model is determined to be operating outside acceptable parameters, or is behaving unexpectedly.

Hence, a result is generated. The result may be to alert a user. The result may be to re-train the test large language model using new parameters, new training data, or a combination thereof. The result may be to replace the test large language model. The result may be to pause execution of the test large language model with respect to some other function for which the test large language model is being used. Other results may be generated.

Attention is now turned to FIG. 3F. FIG. 3F shows an overall data flow of one or more embodiments in a use case. Thus, FIG. 3F may represent a data flow for the method of FIG. 2A.

Initially, the test input (350) is provided to the test large language model (352). The test large language model (352) generates the test output (354).

Then, the test input (350) and the test output (354) are both provided to the encoding model (314). The output of the encoding model (314) is the encoded test input (358) and the encoded test output (360).

The encoded test input (358), the encoded test output (360), and the pre-existing clusters (359) (or possibly the past encoded test inputs and past encoded test outputs) are provided to the cluster assignment model (356). The output of the cluster assignment model (356) is the input cluster (362) (i.e., the cluster to which the encoded test input (358) is assigned) and the output cluster (364) (i.e., the cluster to which the test output (354) is assigned).

The input cluster (362), the output cluster (364), the mapping data (348), and the pre-existing relationships (392) among the clusters (359) are provided as input to the comparison model (390). The output of the comparison model (390) is the relationship (394) between the input cluster (362) and the output cluster (364).

The comparison model (390) also may determine whether the relationship (394) matches one of the pre-existing relationships, at determination process (396). If so (a “yes” determination at the determination process (396)) then the test large language model continues a use process (398A). In other words, no action may be taken. However, if not (a “no” determination at the determination process (396)) then a result is returned at a result process (398B). In other words, a result may be generated.

The result may be to alert a user. The result may be to re-train the test large language model using new parameters, new training data, or a combination thereof. The result may be to replace the test large language model. The result may be to pause execution of the test large language model with respect to some other function for which the test large language model is being used. Other results may be generated.

FIG. 4 shows an example of a graphical user interface usable in a system for detection and remediation of instabilities in large language models, in accordance with one or more embodiments. The graphical user interface (400) shown in FIG. 4 may be implemented using the system shown in FIG. 1A or may be implemented using the computing system and network environment shown in FIG. 5A and FIG. 5B. The graphical user interface (400) shows an example in which the test large language model has been determined to have operated unexpectedly, such as when the method of FIG. 2A resulted in step 212, or when a “no” determination is made at the determination process (396) in FIG. 3F.

The graphical user interface (400) shows two widgets, including the large language model monitoring tools (402) and the large language model maintenance tools (406). The large language model monitoring tools (402) include program code, which when executed by a processor, performs the method shown in FIG. 2A or the data flow in FIG. 3F. In the example of FIG. 4, the test large language model monitored by the large language model monitoring tools (402) has behaved unexpectedly.

The result in the example of FIG. 4 is to generate an alert. Thus, the display window (404) displays the alert that the test large language model may be unstable. The display window (404) also may display the clusters to which the encoded test input and encoded test output of the large language model were assigned. The display window (404) also may display that the assigned clusters for the encoded test input and encoded test output are not known to be associated with each other, which is the basis or reason for why the alert was generated and displayed in the display window (404).

The user may then use the large language model maintenance tools (406) widget to modify the test large language model. The user may use the large language model maintenance tools (406) to retrain the test large language model, replace the test large language model, or take some other action.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores or micro-cores of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output devices may be the same or different from the input device(s) (510). The input and output device(s) may be locally or remotely connected to the computer processor(s) (502). Many different types of computing systems exist, and the aforementioned input and output device(s) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
applying a test large language model to a test input to generate a test output;
applying an encoding model to the test input to generate an encoded test input;
applying the encoding model to the test output to generate an encoded test output;
applying a cluster assignment model to a combination of the encoded test input, the encoded test output, and a plurality of clusters, wherein:
applying the cluster assignment model identifies an input cluster to which the encoded test input belongs and an output cluster to which the encoded test output belongs,
the input cluster is one of the plurality of clusters, and
the output cluster is one of the plurality of clusters;
applying a comparison model to the input cluster and the output cluster to identify a relationship between the input cluster and the output cluster and to determine whether the relationship is one of a plurality of pre-existing relationships among the plurality of clusters; and
responsive to the relationship failing to match at least one of the plurality of pre-existing relationships, returning a result.

2. The method of claim 1, wherein the result is selected from the group consisting of: an alert, an electronic message displayable on a graphical user interface, a command to retrain the test large language model, a command to replace the test large language model with a new large language model, and a command to pause execution of the test large language model.

3. The method of claim 1, wherein returning the result comprises:
adjusting, responsive to the relationship failing to match the at least one of the plurality of pre-existing relationships, a training parameter of the test large language model to generate an adjusted training parameter; and
retraining the test large language model using the adjusted training parameter.

4. The method of claim 1, wherein returning the result comprises:
adjusting, responsive to the relationship failing to match the at least one of the plurality of pre-existing relationships, adjusted training data; and
retraining the test large language model using the adjusted training data.

5. The method of claim 1, further comprising:
applying a clustering model to a plurality of past encoded inputs and a plurality of past encoded outputs to generate the plurality of clusters.

6. The method of claim 5, further comprising:
applying a stable large language model to past inputs to generate a plurality of past outputs;
applying the encoding model to the past inputs to generate the plurality of past encoded inputs; and
applying the encoding model to the past outputs to generate the plurality of past encoded outputs.

7. The method of claim 1, further comprising:
applying a mapping model to the plurality of clusters to generate mapping data defining a plurality of mappings among the plurality of clusters; and
determining the plurality of pre-existing relationships from the plurality of mappings.

8. The method of claim 1, wherein the comparison model takes, as a first comparison input, the input cluster, the output cluster, and mapping data defining a plurality of mappings among the plurality of clusters, and generates, as a first comparison output, the plurality of pre-existing relationships.

9. The method of claim 8, wherein the comparison model further takes, as a second comparison input, the plurality of pre-existing relationships, the input cluster, and the output cluster, and generates, as a second comparison output, the relationship.

10. A method comprising:
applying a stable large language model to past inputs to generate past outputs;
applying an encoding model to the past inputs to generate a plurality of past encoded inputs;
applying the encoding model to the past outputs to generate a plurality of past encoded outputs;
applying a clustering model to the plurality of past encoded inputs and the plurality of past encoded outputs to generate a plurality of clusters;
applying a mapping model to the plurality of clusters to generate mapping data defining a plurality of mappings among the plurality of clusters; and
determining a plurality of pre-existing relationships among the plurality of clusters from the plurality of mappings.

11. The method of claim 10, further comprising:
applying a test large language model to a test input to generate a test output;
applying the encoding model to the test input to generate an encoded test input;
applying the encoding model to the test output to generate an encoded test output;
applying a cluster assignment model to a combination of the encoded test input, the encoded test output, and the plurality of clusters, wherein:
applying the cluster assignment model identifies an input cluster to which the encoded test input belongs and an output cluster to which the encoded test output belongs,
the input cluster is one of the plurality of clusters, and
the output cluster is one of the plurality of clusters;
applying a comparison model to the input cluster and the output cluster to identify whether a relationship between the input cluster and the output cluster is one of the plurality of pre-existing relationships; and
responsive to the relationship failing to match at least one of the plurality of pre-existing relationships, returning a result.

12. A system comprising:
a processor;
a data repository in communication with the processor and storing:
a test input and a test output,
an encoded test input and an encoded test output,
a plurality of clusters,
an input cluster and an output cluster, each comprising one of the plurality of clusters,
a relationship between the input cluster and the output cluster,
a plurality of pre-existing relationships among the plurality of clusters, and
a result;
a test large language model executable by the processor to generate the test output from the test input;
an encoding model executable by the processor to generate the encoded test input and the encoded test output;
a cluster assignment model executable by the processor to a combination of the encoded test input, the encoded test output, and the plurality of clusters, wherein:
the cluster assignment model, when executed, identifies the input cluster to which the encoded test input belongs and the output cluster to which the encoded test output belongs;
a comparison model executable by the processor to identify the relationship between the input cluster and the output cluster and to determine whether the relationship is one of the plurality of pre-existing relationships among the plurality of clusters; and
a server controller executable by the processor to return a result, responsive to the relationship failing to match at least one of the plurality of pre-existing relationships.

13. The system of claim 12, wherein the result is selected from the group consisting of: an alert, an electronic message displayable on a graphical user interface, a command to retrain the test large language model, a command to replace the test large language model with a new large language model, and a command to pause execution of the test large language model.

14. The system of claim 12, wherein the server controller is configured to return the result by:
adjusting, responsive to the relationship failing to match the at least one of the plurality of pre-existing relationships, a training parameter of the test large language model to generate an adjusted training parameter; and
retraining the test large language model using the adjusted training parameter.

15. The system of claim 12, wherein the server controller is configured to return the result by:
adjusting, responsive to the relationship failing to match the at least one of the plurality of pre-existing relationships, adjusted training data; and
retraining the test large language model using the adjusted training data.

16. The system of claim 12, further comprising:
a clustering model executable by the processor on a plurality of past encoded inputs and a plurality of past encoded outputs to generate the plurality of clusters.

17. The system of claim 16, further comprising:
a stable large language model executable by the processor on past inputs to generate a plurality of past outputs, wherein:
the encoding model is executable by the processor on the past inputs to generate the plurality of past encoded inputs; and
the encoding model is executable by the processor on the past outputs to generate the plurality of past encoded outputs.

18. The system of claim 12, further comprising:
a mapping model executable by the processor on the plurality of clusters to generate mapping data defining a plurality of mappings among the plurality of clusters,
wherein the mapping model is further executable by the processor to determine the plurality of pre-existing relationships from the plurality of mappings.

19. The system of claim 12, wherein the comparison model, when executed by the processor, takes, as a first comparison input, the input cluster, the output cluster, and mapping data defining a plurality of mappings among the plurality of clusters, and generates, as a first comparison output, the plurality of pre-existing relationships.

20. The system of claim 19, wherein the comparison model, when executed by the processor, further takes, as a second comparison input, the plurality of pre-existing relationships, the input cluster, and the output cluster, and generates, as a second comparison output, the relationship.
